(19) United States
(12) Patent Application Publication
(10) Pub. No.: US 2017/0328179 A1
(43) Pub. Date: Nov. 16, 2017

(54) Hydraulic Fracturing Apparatus, Methods, and Systems

(71) Applicant: Halliburton Energy Services, Inc., Houston, TX (US)

(72) Inventors: Jason D. Dykstra, Addison, TX (US); Zhijie Sun, Spring, TX (US)

(73) Assignee: Halliburton Energy Services, Inc., Houston, TX (US)

(21) Appl. No.: 15/526,163

(22) PCT Filed: Dec. 31, 2014
(86) PCT No.: PCT/US2014/072941

§ 371 Date: May 11, 2017

(51) Int. Cl. E21B 41/00; G01V 1/28; E21B 47/10; E21B 34/02; E21B 43/267; E21B 43/26; E21B 49/00

(52) U.S. Cl. CPC E21B 41/0092; G01V 1/288; G01V 1/282; E21B 49/00; E21B 34/02; E21B 43/267; E21B 43/26; E21B 47/10

(57) ABSTRACT

In some embodiments, an apparatus and a system, as well as a method and article, may operate to measure one or more properties associated with a fracture in a geological formation to provide a measured property. Further activities may include determining a predictive fracturing model based on the measured property, determining an objective function comprising at least one fracturing objective, generating an actuator input level that satisfies the predictive fracturing model and the fracturing objective of the objective function, and operating a controlled device according to a the actuator input level. Additional apparatus, systems, and methods are disclosed.

### BACKGROUND

Under the current practice of hydraulic fracturing in geological formations, a fracture design is planned based on minifrac testing that is conducted long before the job starts. This type of testing is most useful when determining rock mechanics near the wellbore. However, formation conditions farther from the wellbore, including the aperture and permeability of natural fractures, are simply unknown. In addition, the data from minifrac testing can lead to large uncertainties in estimated parameters, such as the fluid loss coefficient. For these reasons, a fracture plan design based solely on minifrac testing may render less than desirable performance.

### BRIEF DESCRIPTION OF THE DRAWINGS

FIG. 1 is a flow diagram of a predictive control method, according to various embodiments of the invention.

FIG. 2 is an example graph of proppant concentration parameterized by an exponential curve in three-dimensional space, according to various embodiments of the invention.

FIG. 3 is a block diagram of a predictive control system, according to various embodiments of the invention.

FIG. 4 includes illustrations of proppant distribution for an assumed perfect fracture model, comparing results obtained using a fixed fracturing plan versus those obtained when a real-time model predictive control (MPC) strategy is used, according to various embodiments of the invention.

FIG. 5 includes illustrations of proppant distribution when the model leak-off coefficient has changed, comparing results obtained using a fixed fracturing plan versus those obtained when a real-time MPC strategy is used, according to various embodiments of the invention.

FIG. 6 includes illustrations of proppant distribution when the model formation stress is altered, comparing results obtained using a fixed fracturing plan versus those obtained when a real-time MPC strategy is used, according to various embodiments of the invention.

FIG. 7 includes illustrations of proppant distribution when the model includes a natural fracture that opens prior to the induced fracture, comparing results obtained using a fixed fracturing plan versus those obtained when a real-time MPC strategy is used, according to various embodiments of the invention.

FIG. 8 illustrates apparatus and a control system according to various embodiments of the invention.

FIG. 9 is a flow diagram illustrating additional predictive control methods, according to various embodiments of the invention.

FIG. 10 depicts a fracturing site including a fracturing system configured to deliver proppants, fluids, special ingredients, and compositions of these to subterranean formations in accordance with various embodiments.

### DETAILED DESCRIPTION

To address some of the challenges described above, as well as others, apparatus, systems, and methods are described herein that operate to provide real-time control and optimization of fracturing operations based on real-time measurements. For example, in some embodiments, a real-time MPC strategy is used to adjust the fracturing plan based on various microseismic measurements. As a result, formation fluid flow simulators, and operational control systems can operate in a more predictable and reliable fashion. The discussion of this approach begins with an outline of techniques that may be used in various embodiments.

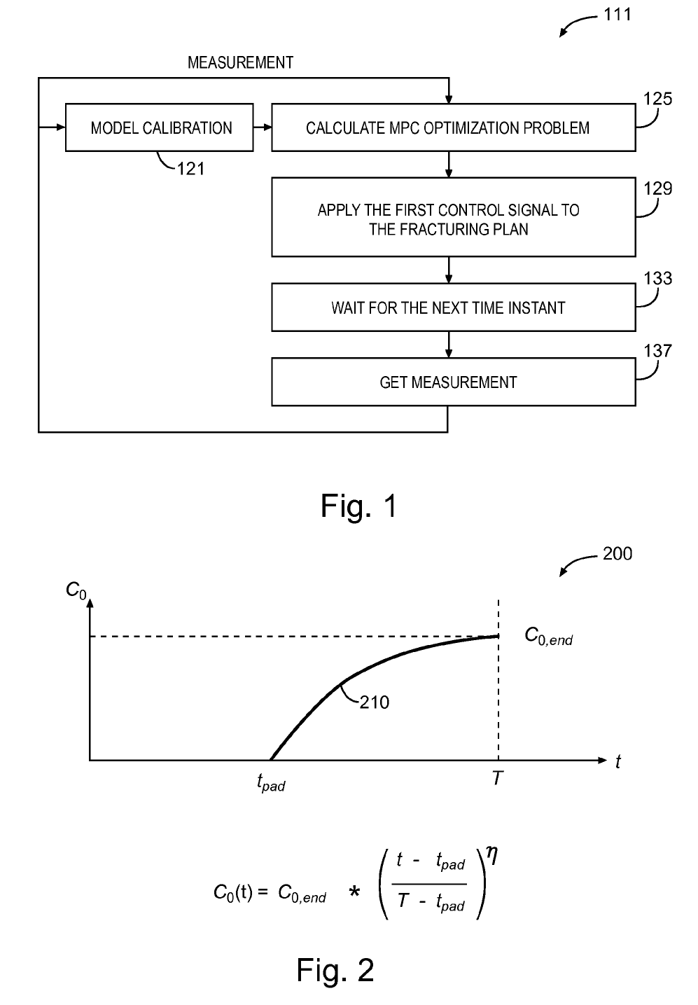

For example, FIG. 1 is a flow diagram of a predictive control method 111, according to various embodiments of the invention. Here a fracture model is selected to guide the real-time operations of an MPC module. Each time a new measurement becomes available, the MPC computes the optimal fracturing plan for the remainder of the job by predicting future fracture growth behavior and minimizing a selected cost function at block 125. At block 129, only the first sampling interval of the fracturing plan is implemented. After the sampling interval has passed at block 133, new measurement data are obtained at block 137, and used to calibrate the model and update the current state of the MPC module at block 121. Based on the calibrated model and updated job state, the MPC module operates to re-optimize the fracturing plan at block 125. The process is repeated until the job ends.

In general, the selected model should be able to predict the value of desired variables in the cost function, which is a weighted sum of one or more control objectives. Examples of control objectives include set point tracking and economic optimization. For example, for a planar fracture, the weighted cost function J may be expressed as follows:

J=W1*(proppant concentration distribution errors)²+W2*(error of fracture conductivity)²+W3*(fracture geometry errors)²+W4*(total proppant consumption)+W5*(total energy consumption),

where the weighting factors might be set as W1=1, and W2, W3, W4, W5=0 for 80% of the job; and W1=0.5 W4=0.5 (while W2, W3, W5=0) for 20% of the job. Many variations are possible, depending on the nature of the job.

For a complex fracture, the conductivity error can be replaced by the stimulated reservoir volume (SRV) or other performance metrics. Note that sometimes set point tracking goals and economic optimization goals are interchangeable, e.g., the fracture conductivity could be targeted to reach as high a value as possible, instead of achieving some desired value.

In some embodiments, a simple constant-height bi-planar fracture is assumed, which can be described by the Perkins-Kern model, as is well known to those of ordinary skill in the art. The fracture is subject to fluid loss into the formation, which is modeled by the classical Carter leak-off model, also well known to those of ordinary skill in the art. In many embodiments, this model, among others, can be used to supply an estimated leak-off rate to adjust the fracturing plan in real time.

The fracturing plan in this example embodiment is therefore defined by two control variables: fracturing fluid pump rate and proppant concentration. The goals of the fracturing job, which defines the cost function, are to extend the fracture to the desired length and to reach a desired evenly-distributed proppant concentration inside the fracture. The optimization problem in the MPC can therefore be explicitly written as:

min_{T,c}_{₀}_{,V}W₁(L(T)−Lₛₚ)²+Σᵢ₌₁^{N}W_{2,i}(cᵢ(T)−cₛₚ)² (1)

subject to
L(t)=ƒ(c₀(t),V(t))
cᵢ(t)=g(c₀(t),V(t)), i=1, . . . , N
0≦c₀(t)≦c₀^{max}
V^{min}≦V(t)≦V^{max}
t_{current}≦T≦T^{max}
   where c₀(t) is the proppant concentration entering the fracture, T denotes the end-of-job time, V(t) is the pump rate, and L is the fracture length. The setpoint Lₛₚ and cₛₚ represent the end-of-job fracture length and end-of-job proppant concentration, respectively.

Assuming the fracture is divided into N sections, then cᵢ(T) denotes the proppant concentration in the i-th section. The functions ƒ(•) and g(•) represent models for length growth and proppant transport, respectively. The input sand concentration, pump rate and job length are bounded by their maximum allowed values. Moreover, the job-end time can only be in the future, i.e., T≧t_{current}.

The terms in the cost functions are weighted by the factors W₁ and W_{2,i}, which balance different control objectives and emphasize factors with greater modeling importance. For instance, since the near-wellbore portion of the fracture usually carries more oil and gas, the amount of sand injected into that part of the fracture should be tightly controlled, and thus the weighting factors W_{2,1} and W_{2,2} (that control the sand concentration in the first and second sections of the fracture) can be greater than others. The optimization problem delineated by Equation (1) may not be readily solved in real time since the control variables c₀(t) and V(t) can be any arbitrary curve between t_{current} to T. Thus, the search space for these two variables is large. However, for the particular cost function shown in Equation (1), the curve of c₀(t) may be parameterized by an exponential function that is characterized by three variables: t_{pad}, which is the time for pad volume (i.e., the volume of clean fluid pumped at the beginning of a hydraulic fracture operation; proppants are added afterward); η, (which adjusts the shape of the curve; and c_{0,end}, which is the proppant concentration at the wellbore at the end of job. Thus, when the job comes to an end, t=T, and c₀(t)=c_{0,end}). Thus, the curve can be parameterized by using the equation:

$${c}_{0} ( t ) = {{c}_{0 , end} ( \frac{t - {t}_{pad}}{T - {t}_{pad}} )}^{η} .$$

This means there are actually four parameters that can be varied (which also constitute the four variables whose optimal values are sought as solutions): t_{pad}, T, c_{0,end} and η.

For example, FIG. 2 is an example graph 200 of proppant concentration parameterized by an exponential curve 210 in three-dimensional space, according to various embodiments of the invention. Here the search space for the variable c₀(t) is now reduced to three dimensions: (t_{pad}, η, c_{0,end}). Note that the end time T depends mostly on the desired fracture length. To reduce the search space for the curve V(t), a controller regulating the pump rate can be introduced, to match the ratio of fluid loss and fluid injection rate to a pre-determined curve. The optimization module in that case only needs to determine the optimal value of T.

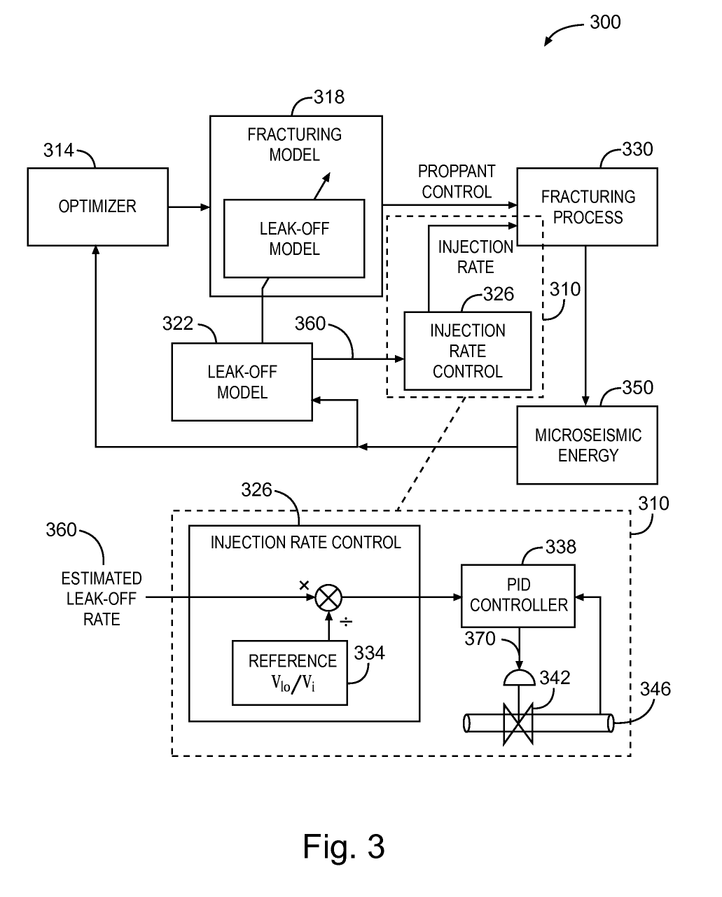

FIG. 3 is a block diagram of a predictive control system 300, according to various embodiments of the invention. The rate controller 310 that forms part of the system 300 is separated to show additional detail in the lower part of the figure.

Here it can be seen that the optimizer 314 is coupled to the fracturing model 318. The optimizer 314 operates to solve the optimization problem presented previously:

$${c}_{0} ( t ) = {{c}_{0 , end} ( \frac{t - {t}_{pad}}{T - {t}_{pad}} )}^{η}$$

The optimizer 314 determines the optimal values for the variables in this equation (or other variables if the search space is characterized by another parameterization). The solution can be computed by any number of available optimization solvers, known to those of ordinary skill in the art, such as Microsoft® Excel spreadsheet software, or MATLAB® numerical analysis software.

The leak-off model 322, which can operate within the fracturing model 318, or apart from it (both are shown in the figure), provides an estimated leak-off rate for fracturing fluid that is pumped into the fracture. The fluid leak-off rate can be estimated in various ways, well-known to those of ordinary skill in the art. Others can refer to various available documents, including U.S. Pat. No. 8,498,852, to learn more about leak-off rate estimation. In some embodiments, the leak-off model 322 is coupled to the injection rate control 326 within the rate controller 310.

The fracturing model 318 is coupled to the fracturing process 330 and to the leak-off model 322, providing one or more signals to control the flow of proppant into the fracture.

The fracturing process 330 is also coupled to the rate controller 310, and receives information that serves to control the fracturing fluid rate of injection Vᵢ(t). This information is developed by the injection rate control 326, using input from a reference 334, which provides a value for the controller 338 to determine the value of the injection rate Vᵢ(t). For example, if the pre-stored/pre-determined reference 334 value says that when the fracture length reaches 50 m in length, the ratio of the leak-off rate V_{Io}(t) and injection rate Vᵢ(t) should be 0.2, then the value sent to the controller 338 is the estimated leak-off rate 360 (provided by the leak-off model 322) divided by 0.2. The controller 338 would then operate to adjust the device 342 so that the flow rate in the pipeline 346 is the value calculated by the injection rate control 326 and sent to the controller 338. That is, the controller 338 may operate a valve or other device 342 by applying an actuator input level 370, perhaps using feedback that is measured as a result of device 342 activity (e.g., pressure in the pipeline 346) as an additional mechanism for control.

Measurements 350 that correlate to microseismic energy generated as a result of the fracturing process 330 are coupled to the optimizer 314 to enable further processing, as described with respect to the method 111 in FIG. 1. As a fracture extends, it may cause micro-earthquakes, which in some embodiments are detected by sensors on the surface (e.g., tilt meters) or by sensors in an observation well nearby (e.g., geophones). By noting the location of the micro-earthquakes via microseismic monitoring, the characteristics of the fracture, including fracture geometry (e.g., fracture length), can be determined, as is well-known to those of ordinary skill in the art.

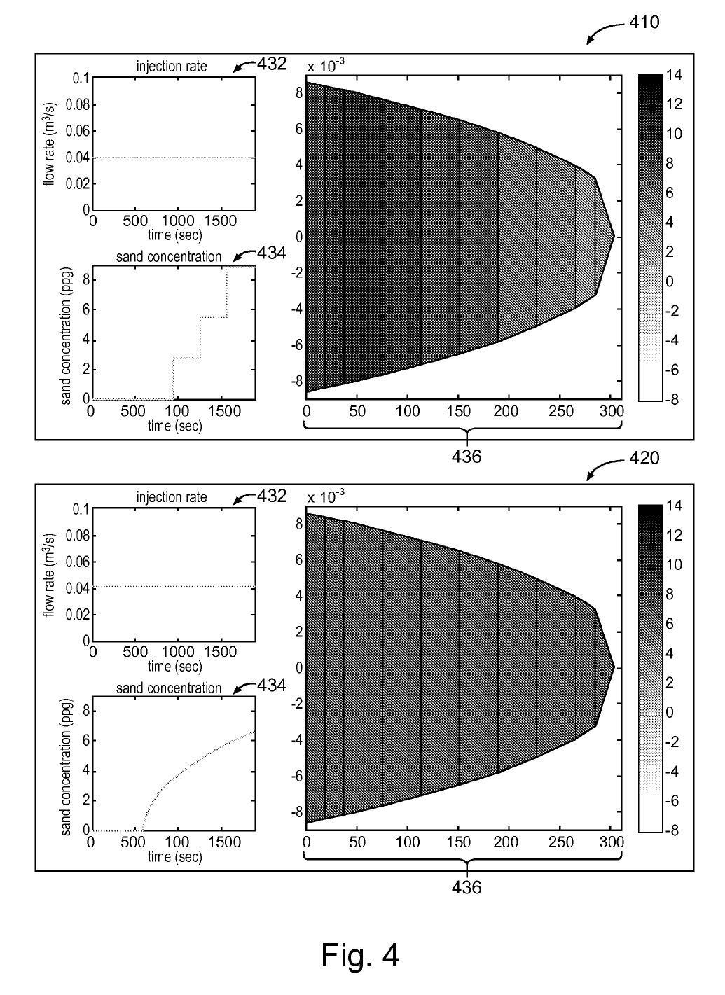

FIG. 4 includes illustrations 410, 420 of proppant distribution for an assumed perfect fracture model, comparing results obtained using a fixed fracturing plan (upper illustration 410) versus those obtained when a real-time model predictive control (MPC) strategy (lower illustration 420) is used, according to various embodiments of the invention. It should be noted that in each illustration 410, 420 of FIG. 4, the upper left-hand graph 432 indicates the fracture fluid injection rate over time, the lower left-hand graph 434 indicates the proppant/sand concentration over time, and the shaded graph/legend 436 on the right indicates the concentration of proppant in the fracture.

In FIG. 4, a perfect model is assumed to be known by the controller. The simulation results show that the proppant in the fracture (see graph/legend 436 for illustration 420) generated under real-time control is more evenly distributed than proppants in the fracture generated by a conventional step-up proppant schedule (see graph/legend 436 for illustration 410). However, a perfectly known model is almost impossible to acquire in practice.

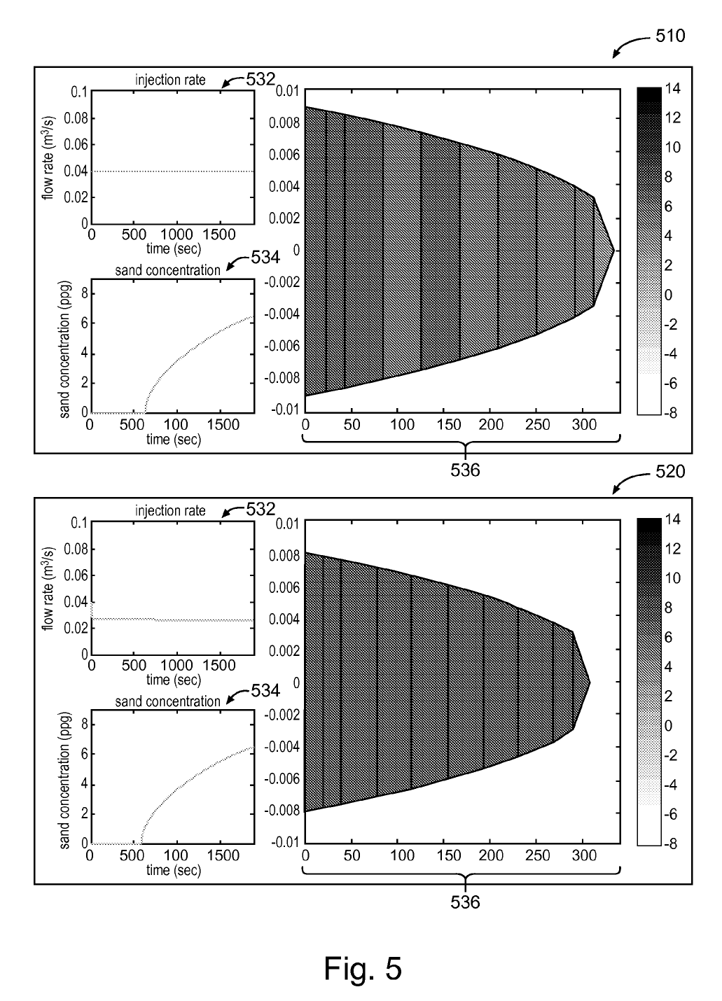

FIG. 5 includes illustrations of proppant distribution when the model leak-off coefficient has changed, comparing results obtained using a fixed fracturing plan (upper illustration 510) versus those obtained when a real-time MPC strategy (lower illustration 520) is used, according to various embodiments of the invention. It should be noted that in each illustration 510, 520 of FIG. 5, the upper left-hand graph 532 indicates the fracture fluid injection rate over time, the lower left-hand graph 534 indicates the proppant/sand concentration over time, and the shaded graph/legend 536 on the right indicates the concentration of proppant in the fracture.

A slight change in the leak-off coefficient has been introduced in the case shown in FIG. 5, as compared to the perfect model of FIG. 4. In FIG. 5, it can be observed that under real-time control (see graph/legend 536 in illustration 520) at the very beginning the injection rate controller gradually reduces the flow rate (see element 532 in illustration 520) as learned by the leak-off estimation module. The flow rate eventually approaches some value that matches the real leak-off rate. The sand concentration profile (see element 534 in illustration 520) is also adjusted to the optimal curve according to the environmental changes.

As a matter of contrast, a fixed fracturing plan with a constant flow rate and fixed proppant schedule (shown in illustration 510) may not take into account the changes that occur down hole, producing a fracture which is longer than required and has less proppant at the tip than elsewhere (see graph/legend 536 in illustration 510).

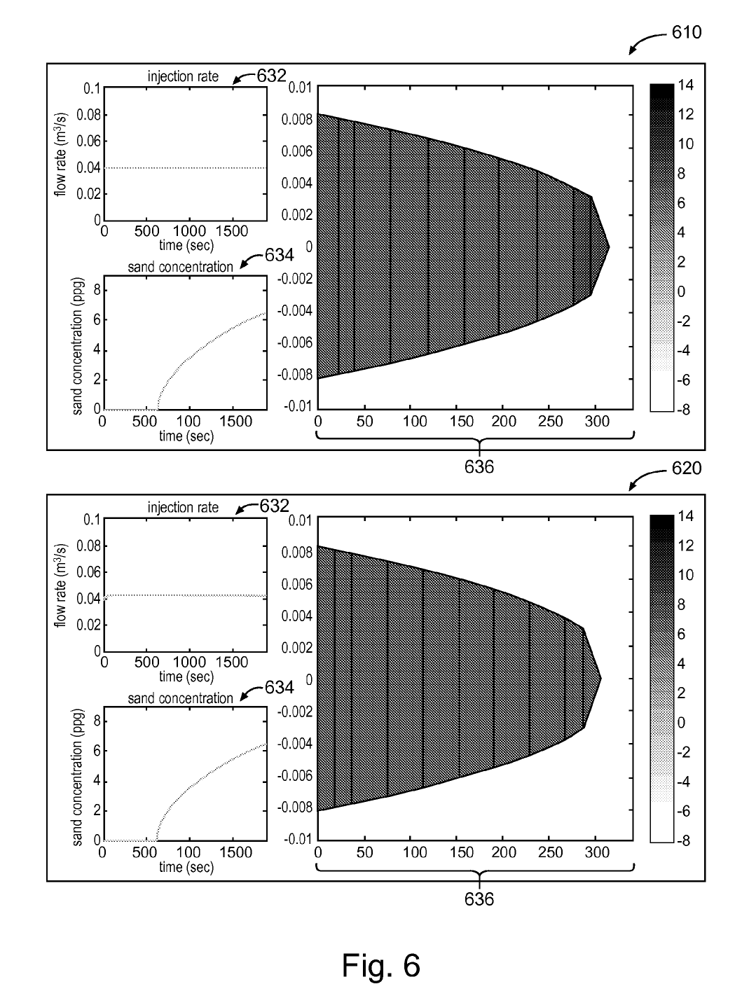

FIG. 6 includes illustrations of proppant distribution when the model formation stress is altered, comparing results obtained using a fixed fracturing plan (upper illustration 610) versus those obtained when a real-time MPC strategy (lower illustration 620) is used, according to various embodiments of the invention. It should be noted that in each illustration 610, 620 of FIG. 6, the upper left-hand graph 632 indicates the fracture fluid injection rate over time, the lower left-hand graph 634 indicates the proppant/sand concentration over time, and the shaded graph/legend 636 on the right indicates the concentration of proppant in the fracture. With respect to the concentration of the proppant, it is noted that the fracture in each case was divided into ten sections, with W₁=1 and W_{2,i}=0.001, for i=1, . . . , 10.

In this case, the formation stress, or more specifically, the shear modulus of rock has been altered, in comparison with the perfect model. This phenomena is called “stress shadow” by those of ordinary skill in the art, and commonly occurs when nearby fractures exist. The fracture in this case is easier to extend as a result of increased formation stress. As was noted for FIGS. 4 and 5, a real-time controller in this case (see illustration 620) can be used to compensate for changes in the surrounding formation, to provide a fracture that more precisely meets design requirements (e.g., has a more even and economical distribution of proppants), in comparison to the more conventional fixed plan, with a fixed injection rate (see illustration 510).

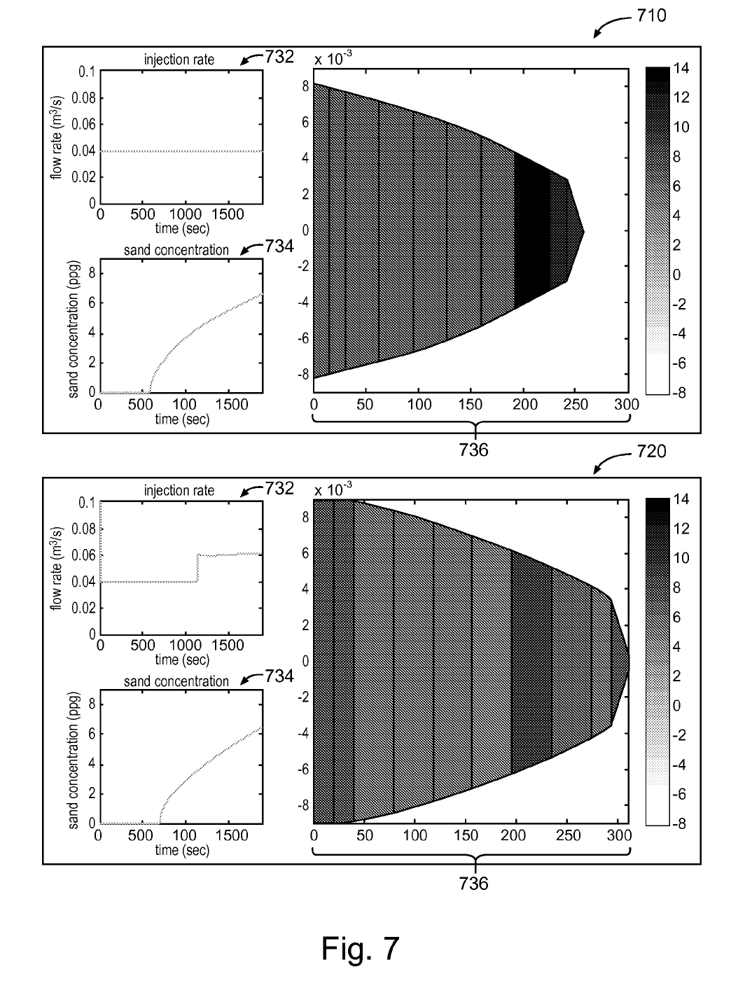

FIG. 7 includes illustrations of proppant distribution when the model includes a natural fracture that opens prior to the induced fracture, comparing results obtained using a fixed fracturing plan (upper illustration 710) versus those obtained when a real-time MPC strategy (lower illustration 720) is used, according to various embodiments of the invention. It should be noted that in each illustration 710, 720 of FIG. 7, the upper left-hand graph 732 indicates the fracture fluid injection rate over time, the lower left-hand graph 734 indicates the proppant/sand concentration over time, and the shaded graph/legend 736 on the right indicates the concentration of proppant in the fracture.

In this case, a natural fracture opening ahead of the induced fracture is simulated. The natural fracture is assumed to be approximately 200 m away from the wellbore, where a fracture will be induced. The natural fracture will most likely accept only fracturing fluid, not proppants, since the width of natural fractures is typically on the order of micrometers—significantly smaller than the diameter of proppants. As a result, the proppant concentration will increase, due to a phenomenon known as dehydration by those of ordinary skill in the art.

When a leak-off estimator is used, as part of an MPC strategy, the additional leak-off due to dehydration is taken into account, and corrective action to increase the pumping rate occurs (see graph 732 in illustration 720). At the same time, the proppant schedule is adjusted to cope with the increasing fluid injection rate.

As a matter of contrast, the fixed fracturing design is blind to the extra fluid loss and the pump rate is maintained, even after the natural fracture begins to accept fracturing fluid. As a consequence, the proppant concentration near the tip of the fracture is much higher than desired (see graph/legend 736 in illustration 710), causing unwanted tip screen-out. The fracture length is also significantly shortened.

In sum, by reviewing FIGS. 4-7, it can be seen that real-time control can often provide a better outcome than conventional, fixed hydraulic fracturing plans. Many embodiments may thus be realized.

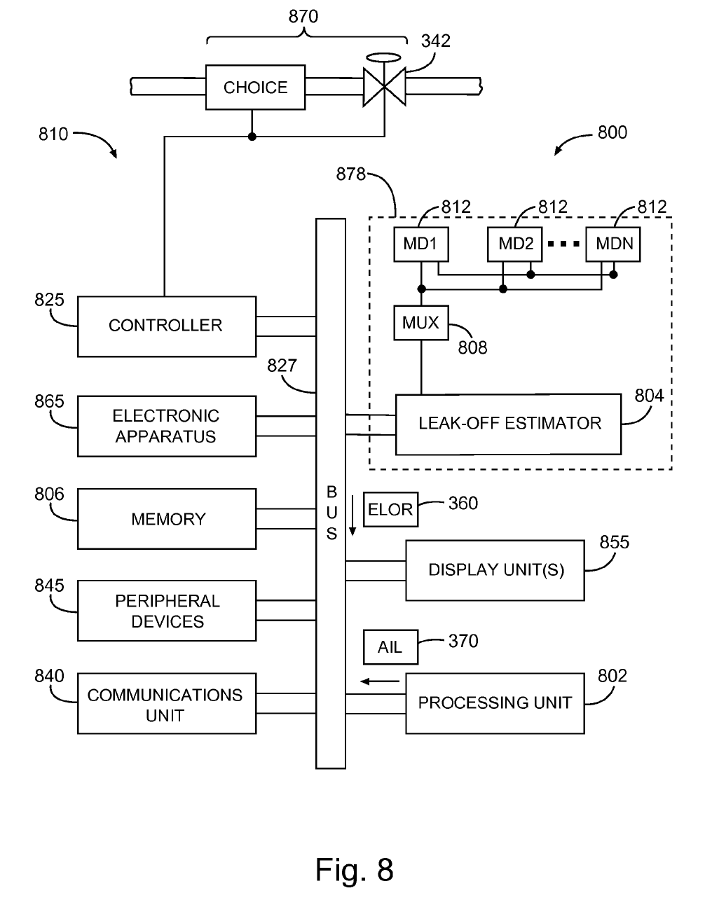

For example, FIG. 8 illustrates apparatus 800 and a control system 810 according to various embodiments of the invention. The apparatus 800 and system 810 may form part of a laboratory flow simulator, a piping valve control system, and many others. In some embodiments, the apparatus 800 and system 810 are operable within a wellbore, or in conjunction with wireline and drilling operations, as will be discussed later.

In many embodiments, the apparatus 800 and system 810 can receive environmental measurement data via one or more external measurement devices (e.g., a fluid parameter measurement device to measure temperature, pressure, flow velocity, and/or volume, etc.) 812. Other peripheral devices and sensors 845 may also contribute information to assist in the identification and measurement of fractures, proppant flow, proppant concentration, and the simulation of various values that contribute to system operation.

The processing unit 802 can perform fracture identification and property measurement, predictive fracturing model selection, and objective function identification, among other functions, when executing instructions that carry out the methods described herein. These instructions may be stored in a memory, such as the memory 806. These instructions can transform a general purpose processor into the specific processing unit 802 that can then be used to generate an actuator input level 370. The actuator input level 370 can be supplied to the controlled device (e.g. choke and/or valve) 870 directly, via the bus 827, or indirectly, via the controller 825. In either case, actuator input level 370 commands are delivered to the controlled device 870 to effect changes in the structure and operation of the controlled device 870 in a predictable fashion.

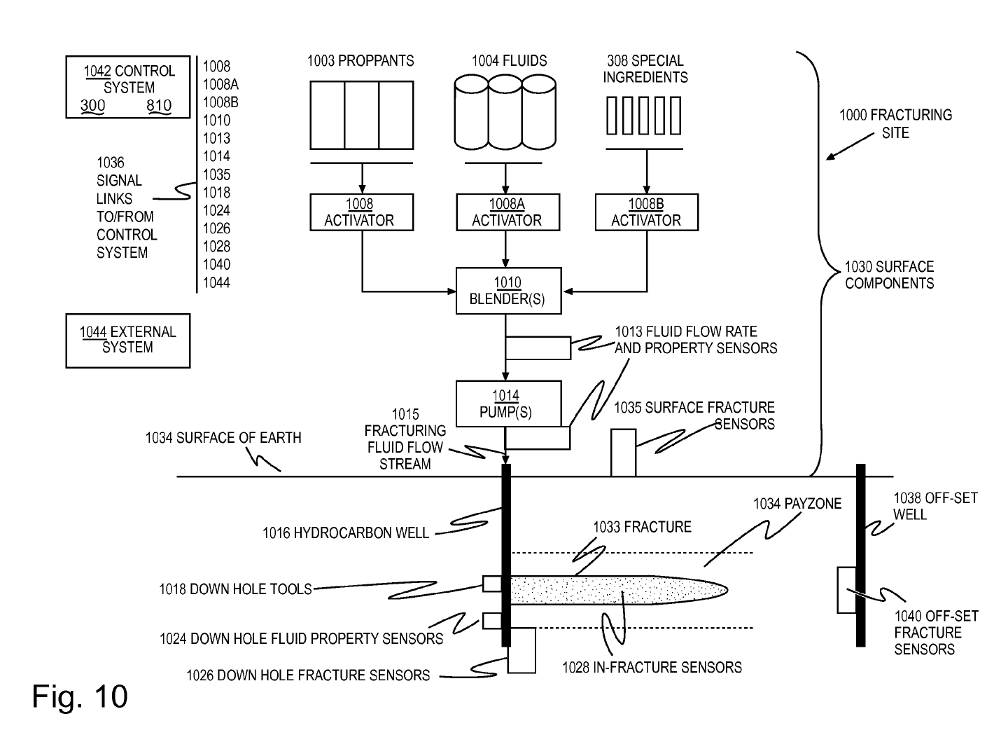

As will be described in more detail below, in some embodiments, a housing 878, such as a wireline tool body, or a downhole tool, can be used to house one or more components of the apparatus 800 and system 810. as described in more detail below with reference to FIGS. 10 and 11. The processing unit 802 may be part of a surface workstation or attached to a downhole tool housing.

The apparatus 800 and system 810 can include other electronic apparatus 865 (e.g., electrical and electromechanical valves and other types of actuators), and a communications unit 840, perhaps comprising a telemetry receiver, transmitter, or transceiver. The controller 825 and the processing unit 802 can each be fabricated to operate the measurement device(s) 812 to acquire measurement data, including but not limited to measurements representing any of the physical parameters described herein. Thus, in some embodiments, such measurements are made within the physical world, and in others, such measurements are simulated. In many embodiments, physical parameter values are provided as a mixture of simulated values and measured values, taken from the real-world environment. The measurement devices 812 may be disposed directly within a formation, or attached to another apparatus 800 (e.g., a drill string, sonde, conduit, housing, or a container of some type) to sample formation and fluid flow characteristics.

The bus 827 that may form part of an apparatus 800 or system 810 can be used to provide common electrical signal paths between any of the components shown in FIG. 8. The bus 827 can include an address bus, a data bus, and a control bus, each independently configured. The bus 827 can also use common conductive lines for providing one or more of address, data, or control, the use of which can be regulated by the processing unit 802, and/or the controller 825.

The bus 827 can include circuitry forming part of a communication network. The bus 827 can be configured such that the components of the system 810 are distributed. Such distribution can be arranged between downhole components and components that can be disposed on the surface of the Earth. Alternatively, several of these components can be co-located, such as in or on one or more collars of a drill string or as part of a wireline structure.

In various embodiments, the apparatus 800 and system 810 includes peripheral devices, such as one or more displays 855, additional storage memory, or other devices that may operate in conjunction with the controller 825 or the processing unit 802.

Displays 855 can be used to display diagnostic information, measurement information, model and function information, control system commands, as well as combinations of these, based on the signals generated and received, according to various method embodiments described herein. The displays 855 may be used to track the values of one or more measured flow parameters, simulated flow parameters, and fracture parameters to initiate an alarm or a signal that results in activating functions performed by the controller 825 and/or the controlled device 870.

In an embodiment, the controller 825 can be fabricated to include one or more processors. The display 855 can be fabricated or programmed to operate with instructions stored in the processing unit 802 (and/or in the memory 806) to implement a user interface to manage the operation of the apparatus 800 or components distributed within the system 810. This type of user interface can be operated in conjunction with the communications unit 840 and the bus 827.

Various components of the system 810 can be integrated with the apparatus 800 or associated housing 878 such that processing identical to or similar to the methods discussed with respect to various embodiments herein can be performed downhole. In some embodiments, a leak-off estimator module 804 receives measurements from one or more measurement devices 812, perhaps via a multiplexer 808, to provide the estimated leak-off rate 360 to the processing unit 802.

In various embodiments, a non-transitory machine-readable storage device can comprise instructions stored thereon, which, when performed by a machine, cause the machine to become a customized, particular machine that performs operations comprising one or more features similar to or identical to those described with respect to the methods and techniques described herein. A machine-readable storage device is a physical device that stores information (e.g., instructions, data), which when stored, alters the physical structure of the device. Examples of machine-readable storage devices can include, but are not limited to, memory 806 in the form of read only memory (ROM), random access memory (RAM), a magnetic disk storage device, an optical storage device, a flash memory, and other electronic, magnetic, or optical memory devices, including combinations thereof.

The physical structure of stored instructions may be operated on by one or more processors such as, for example, the processing unit 802. Operating on these physical structures can cause the machine to perform operations according to methods described herein. The instructions can include instructions to cause the processing unit 802 to store associated data or other data in the memory 806. The memory 806 can store the results of measurements of fluid, formations, fractures, and other parameters. The memory 806 can store a log of measurements that have been made. The memory 806 therefore may include a database, for example a relational database. Thus, still further embodiments may be realized.

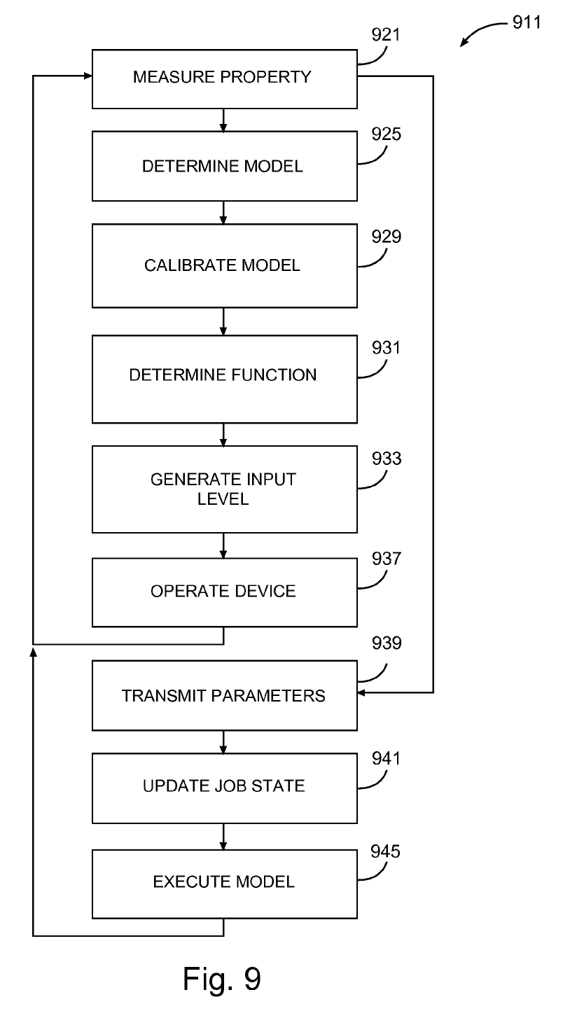

For example, FIG. 9 is a flow diagram illustrating additional predictive control methods 911, according to various embodiments of the invention. The methods 911 described herein include and build upon the methods, apparatus, systems, and information illustrated in FIGS. 1-8. Some operations of the methods 911 can be performed in whole or in part by the system 300, the system 810, or any component thereof (FIGS. 3 and 8).

Thus, referring now to FIGS. 1, 3, and 8-9, it can be seen that in some embodiments, a method 911 begins with measuring at least one property associated with a fracture in a geological formation to provide a measured property.

For example, formation properties might be measured to determine fracture geometry. Thus, the activity at block 921 may include measuring the at least one property associated with a fracture to determine geometry of the fracture. In some embodiments, microseismic activity can be monitored to adjust the injection of fracturing fluid and proppant. Thus, the activity at block 921 may comprise monitoring the at least one property as at least one microseismic condition in the geological formation, perhaps to feed the measured property to a leak-off estimator module (as described below).

In some embodiments, fracture fluid and proppant are injected into the formation by controlled devices according to measured properties of the formation, and a predictive fracturing model. Thus, the method 911 may continue on from block 921 to block 925, to include determining a predictive fracturing model based on the measured property.

The predictive fracturing model can be calibrated, perhaps based on measurements of the formation. Thus, the model may be calibrated by collecting historical data, finding an appropriate model structure, and obtaining the best estimate of the parameters in the model structure. However, in some embodiments, the calibration is purely data-driven. That is, after collecting historical data, a dynamic model is constructed directly from the data (e.g., via machine learning or a neural network) without specifying a model structure based on a priori knowledge. In either case, the method 911 may comprise calibrating the predictive model at block 929.

In some embodiments, the method 911 may continue on to block 931 to include determining an objective function comprising at least one fracturing objective.

In most embodiments, the method 911 continues on to block 933 to include generating an actuator input level that satisfies the predictive fracturing model and the fracturing objective of the objective function.

The fracturing objective may be satisfied in a number of ways. For example, in some embodiments, satisfying the fracturing objective includes at least one of following a set point or minimizing a cost function.

In some embodiments, the method 911 may continue on to block 937 to include operating a controlled device according to the actuator input level. The controlled device can be operated to adjust the condition of the fracture. Thus, the activity at block 937 may include operating the controlled device to provide a desired condition of the fracture at a selected future time, corresponding to the time of the next measurement of the at least one property.

The controlled device may comprise one or more elements. For example, in some embodiments, the operations at block 937 comprise operating the controlled device as a pump to inject fluid into the fracture. In some embodiments, the operations at block 937 comprise operating the controlled device comprising one of a solenoid, a switch, a transistor, or an input/output port.

The fracture can be displayed as a two or three-dimensional image that changes with the measured property. Thus, in some embodiments, the operations at block 937 comprise operating the controlled device as an operator's display that includes a multi-dimensional image of the fracture that is revised according to a value of the measured property.

The controlled device may comprise a programmed controller. Thus, the operations at block 937 comprise operating the controlled device as a proportional-integral-derivative (PID) controller.

In some embodiments, a leak-off estimator module may operate to drive an injection rate control. Examples of parameters that may be generated by the leak-off estimator module include the leak-off coefficient for Carter's leak-off model, known to those of ordinary skill in the art, and/or the spurt-loss coefficient, if spurt loss is taken into account, as part of the activities embodied by the method 911. Thus, in some embodiments, after one or more properties are measured at block 921, the method 911 continues on to block 939 with transmitting parameters generated by the leak-off estimator module to the leak-off model and an injection rate control.

In some embodiments, the method 911 may then continue on to block 941 to include updating a job state of a predictive fracturing model comprising a leak-off model, based on the measured property. The method 911 may then continue on to block 945 with executing the predictive fracturing model to operate a first device (e.g., a first valve) to control an amount of fracturing fluid injected into the geological formation, and a second device (e.g., a second valve or a mixing apparatus) to control an amount of proppant that is injected into the geological formation.

The predictive fracturing model may comprise a weighted cost function that includes a variety of parameters, such as proppant concentration distribution errors, error of fracture conductivity, fracture geometry errors, proppant consumption, and energy consumption, among others. Thus, the activity at block 945 may comprise minimizing a weighted cost function comprising values of at least proppant concentration distribution errors and proppant consumption.

The fracturing plan may be simplified to control the rate of fracturing fluid injection, and the proppant concentration. Thus, in some embodiments, the amount of fracturing fluid injected into the geological formation may be controlled as a rate of injection. In addition, or alternatively, the amount of proppant that is injected into the geological formation may be controlled as a concentration of the proppant.

Thus, it should be noted that the methods described herein do not have to be executed in the order described, or in any particular order. Moreover, various activities described with respect to the methods identified herein can be executed in iterative, serial, or parallel fashion. As just one example, a method 911 may comprise updating the job state of a predictive model based on geological formation measurements at block 941, and executing the model at block 945 to provide an actuator input level at block 933 to operate a controlled device at block 937. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, FIG. 10 depicts a fracturing site 1000 including a fracturing system configured to deliver proppants, fluids, special ingredients, and compositions of these to subterranean formations in accordance with various embodiments. Site 1000 can be located on land or on or in a water environment. For simplicity, the following discussion will refer to a land-based site, although various embodiments are not to be limited thereto.

The site 1000 can contain one or more proppant stores 1003 which contain one or more different proppant types or grades as would be known to one of ordinary skill in the art of proppant specification and design. The site can contain one or more fluid storage systems 1004 for water, solvents, non-aqueous fluids, pad fluids, pre-pad-fluids, viscous fluids for suspending proppants, and liquid components to formulate fracturing fluids as would be known to open skilled in the art of fracturing fluid specification and design. The site can contain one or more special solid or liquid ingredient stores 1006 which have specialized functions in the fracturing and propping processes.

The flow actuation and control of proppants 1003, fluids 1004, and special ingredients 1006 can be controlled by activators 1008, 1008A, and 1008B, respectively. One or more blenders 1010 can receive the proppants 1003, the fluids 1004, and special ingredients 1006 to prepare fracturing and propping fluids in various proportions. One or more pumps 1014 can pump the resulting fracturing and propping fluids down-hole into hydrocarbon well 1016 beneath the surface of the earth 1034.

Components 1003, 1004, 1006, 1008, 1008A, 1008B, 1010, 1013, 1014, 1035, and 1042 comprise surface components 1030. Sensors 1013 can monitor the fracturing and propping fluid flow rates, as well as the properties of the fluids, at positions either before or after the pumps 1014, or at both locations. Down hole tools 1018 can act directly on the fracturing and propping fluids to control the values of the properties of the fluids as the fluids create and enter fracture 1033, which is shown, for simplicity of illustration, in one direction from well 1016.

Down hole fluid property sensors 1024 can measure the fluid property values as the fluids enter fracture 1033. In-fracture fluid sensors 1028 can sense the fluid property values of the fluid inside the fracture. Down hole fracture sensors 1026 can sense the dimensions of fracture 1033 from a down hole location. Off-set fracture sensors 1040 can sense the dimensions of fracture 1033 from an offset location down hole in a different well 1038. Surface fracture sensors 1035 can sense the dimensions of fracture 1033 from the surface of the Earth.

The control system 1042, which may comprise any one or more elements of the systems 300 and/or 810 of FIGS. 3 and 8, respectively, can be linked via signal links 1036 to the listed components. The control system 1042 can also be linked to an external system 1044 which in some embodiments can be an external data collection or supervisory control system. The control system 1042 can implement any one or more of the method embodiments described herein in FIGS. 1 and 9. The control system 1042 can thus obtain and maintain a desired subterranean fracture profile consistent with this disclosure.

Turning now to FIGS. 1, 3, and 8-10, it can be seen that the methods 111, 911 of FIG. 1 and FIG. 9, respectively, as well as the systems 300, 810 of FIG. 3 and FIG. 8, respectively, can thus be employed to conduct fracturing on a site such as fracturing site 1000. The methods 111 and 911 of FIG. 1 can be employed as part of control system 1042 or external system 1044 to conduct fracturing on site 1000. These methods can be used to conduct and control the fracturing and proppant injection process being used to create and prop fracture 1033 within pay zone 1034 in hydrocarbon well 1016 using the fracturing fluid flow stream 1015.

As is known to one of ordinary skill in the art of fracturing geological formations, a fracturing plan can be designed to achieve a particular increase in hydrocarbon production from an operating well, using techniques such as the mini-fracture test prior to actual fracturing. A fracturing plan can also be designed for a newly-created well to achieve a higher output upon start-up of the well had the fracturing operation not been conducted. Thus, in some embodiments, a fracturing plan comprises a time series of desired geometric parameters, locations, and dimensions of fracture 1033 over the time the fracturing process is conducted, and the concentration and distribution of proppant within the fracture. As noted previously, these fixed plans may produce less than desirable results.

Those of ordinary skill in the art understand that fracturing plans may be constructed using fracture profile matrices, to include a propagation function of the fracture length dimension over time, the fracture height dimension over time and distance down the fracture length, and the fracture width dimension over time and the distance down the fracture length. Those of ordinary skill in the art also know that a proppant placement function over time and over the length of the fracture can be developed using the concentration of the proppant over distance and time. Fracturing fluid flow stream properties such as flow rate, viscosity, and density can be used to determine the fracturing fluid viscosity function μ(t), the fracturing fluid pumping flow rate function R(t), and fracturing fluid density function ρ(t). Those that seek more detailed information about the construction and use of fracture plans, which are well-known to those of ordinary skill in the art, may refer to documents in the published literature, including U.S. Pat. Nos. 7,516,793; 6,978,83182; 6,959,773; 6,938,690; and 6,719,055; among others.

To form a control system according to some embodiments described herein, the errors between actual states and desired states can be developed and applied to adjust fracturing activity, by taking leak-off rates into account, and generating drive vectors for the fracturing fluid making and supply system as surface components 1030, as well as for down-hole tools 1018, to be fed to control system 1042. The control system 1042 can then output signals to control the surface and down-hole tools of the fracturing system, such as generally shown in the site 1000.

The fracturing model can be used not only to create an initial fracture plan, but to estimate the current state of the fracture during fracturing in real-time. This estimate can use fracture well sensors, such as down-hole sensors 1026 and/or off-set sensors 1040 and/or surface sensors 1035. Thus, many embodiments may be realized.

For example, referring now to FIGS. 1-10, it can be seen that a system 810 may comprise at least one measurement device (e.g., elements 350, 812, 1013, 1024, 1026, 1028, 1035, and/or 1040) to measure at least one property associated with a fracture 1033 in a geological formation (e.g., pay zone 1034) as a measured property. The system 810 may further include a processing unit (e.g., elements 802, 825, 1042) to receive an estimated leak-off rate 360 based on the measured property, and to implement a fracturing model that responsively generates an actuator input level 370 (e.g., via one or more of the signal links 1036). In many embodiments, the system 810 comprises a fracturing fluid injection valve (e.g., as part of a controlled device 342) coupled to the processing unit to operate in response to the actuator input level 370.

In some embodiments, the system 810 includes a leak-off estimator module 804 to provide the estimated leak-off rate to the processing unit 802.

Some embodiments of the system 810 may include a controller 825. Thus, the system 810 may comprise a proportional-integral-derivative controller 338 to couple the processing unit 802 to the valve, operating as a controlled device 342.

As noted previously, a variety of devices can be used to measure fracture properties. For example, the at least one measurement device 812 may comprise one or more of geophones, accelerometers, or tilt meters, as well as combinations of these.

In some embodiments, measurement devices can be attached to downhole logging tools. Thus, the system 810 may comprise a housing 878, including a downhole logging tool attached to the at least one measurement device.

In some embodiments, the system 810 may include a choke, which is put in line before or after the fracturing fluid valve—to effectively control the pumping rate. Thus, the system 810 may comprise a fracturing fluid injection valve coupled to a choke (e.g., operating as a pair of controlled devices 870) to adjust pressure and flow rate of the fracturing fluid.

Many advantages can be gained by implementing the methods, apparatus, and systems described herein. For example, in some embodiments, a fracture can be created with desired reach to reservoir and conductivity. The fracturing plan can be dynamically adjusted according to real-time measurements, as often as measurements are available. The various embodiments can operate to completely change the conventional practice of using a predetermined fracturing plan, with a fixed pump rate and step-up/ramp-up proppant concentration. When various embodiments are applied to hydraulic fracturing operations, customers receive a better fracture result with less time and material costs. These advantages can significantly enhance the value of the services provided by an operation/exploration company, helping to reduce time-related costs and increase customer satisfaction.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Although specific embodiments have been illustrated and described herein, it will be appreciated by those of ordinary skill in the art that any arrangement that is calculated to achieve the same purpose may be substituted for the specific embodiments shown. Various embodiments use permutations or combinations of embodiments described herein. It is to be understood that the above description is therefore intended to be illustrative, and not restrictive, and that the phraseology or terminology employed herein is for the purpose of description. Combinations of the above embodiments and other embodiments will be apparent to those of ordinary skill in the art upon studying the above description.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
measuring at least one property associated with a fracture in a geological formation to provide a measured property;
determining a predictive fracturing model based on the measured property;
determining an objective function comprising at least one fracturing objective;
generating an actuator input level that satisfies the predictive fracturing model and the fracturing objective of the objective function; and
operating a controlled device according to the actuator input level.

2. The method of claim 1, wherein the operating further comprises:
operating the controlled device to provide a desired condition of the fracture at a selected future time corresponding to a time of a next measurement of the at least one property.

3. The method of claim 1, further comprising:
calibrating the predictive model.

4. The method of claim 1, wherein the measuring further comprises:
measuring the at least one property associated with the fracture to determine geometry of the fracture.

5. The method of claim 1, wherein the operating further comprises:
operating the controlled device as a pump to inject fluid into the fracture.

6. The method of claim 1, wherein the operating further comprises:
operating the controlled device comprising one of a solenoid, a switch, a transistor, or an input/output port.

7. The method of claim 1, wherein the operating further comprises:
operating the controlled device as an operator's display that includes a multi-dimensional image of the fracture that is revised according to a value of the measured property.

8. The method of claim 1, wherein the operating further comprises:
operating the controlled device as a proportional-integral-derivative controller.

9. The method of claim 1, wherein satisfying the fracturing objective includes at least one of following a set point or minimizing a cost function.

10. A method, comprising:
measuring at least one property associated with a fracture in a geological formation to provide a measured property;
updating a job state of a predictive fracturing model comprising a leak-off model, based on the measured property; and
executing the predictive fracturing model to operate a first device to control an amount of fracturing fluid injected into the geological formation, and a second device to control an amount of proppant that is injected into the geological formation.

11. The method of claim 10, wherein the measuring further comprises:
monitoring the at least one property as at least one microseismic condition in the geological formation, to feed the measured property to a leak-off estimator module.

12. The method of claim 11, further comprising:
transmitting parameters generated by the leak-off estimator module to the leak-off model and an injection rate control.

13. The method of claim 10, wherein the executing comprises:
minimizing a weighted cost function comprising values of at least proppant concentration distribution errors and proppant consumption.

14. The method of claim 10, wherein the amount of fracturing fluid injected into the geological formation is controlled as a rate of injection.

15. The method of claim 10, wherein the amount of proppant that is injected into the geological formation is controlled as a concentration of the proppant.

16. A system, comprising:
at least one measurement device to measure at least one property associated with a fracture in a geological formation as a measured property;
a processing unit to receive an estimated leak-off rate based on the measured property, and to implement a fracturing model that responsively generates an actuator input level; and
a fracturing fluid injection valve coupled to the processing unit to operate in response to the actuator input level.

17. The system of claim 16, wherein the at least one measurement device comprises at least one of a geophone, an accelerometer, or a tilt meter.

18. The system of claim 16, further comprising:
a downhole logging tool attached to the at least one measurement device.

19. The system of claim 16, wherein the fracturing fluid injection valve is coupled to a choke to adjust pressure and flow rate of the fracturing fluid.

20. The system of claim 16, further comprising:
a proportional-integral-derivative controller to couple the processing unit to the valve.

21. The system of claim 16, further comprising:
a leak-off estimator module to provide the estimated leak-off rate to the processing unit.
